(19) United States
(12) Patent Application Publication
(10) Pub. No.: US 2005/0179009 A1
(43) Pub. Date: Aug. 18, 2005

(54) Phosphor and a method of preparing the same

(76) Inventors: Gyun-joong Kim, Chungcheongbuk-do (KR); Tae-hyun Kwon, Daejeon-si (KR); Kwang-wook Choi, Daejeon-si (KR); Won-kyoung Oh, Chungcheongbuk-do (KR); Min-soo Kang, Daejeon-si (KR); Se-hwa Kim, Seoul (KR)

Correspondence Address: MCKENNA LONG & ALDRIDGE LLP, 1900 K STREET, NW, WASHINGTON, DC, 20006, US

(21) Appl. No.: 11/017,220

(22) Filed: Dec. 21, 2004

(30) Foreign Application Priority Data
Dec. 23, 2003 (KR) 10-2003-0095816

(51) Int. Cl. C09K 11/08

(52) U.S. Cl. 252/301.4 R; 428/403

(57) ABSTRACT

Provided are a novel blue BAM phosphor and a preparation method thereof. In the blue-emitting phosphor, a magnetoplumbite phase is epitaxially formed as a protection film on the β-phase of a blue BAM phosphor. The blue-emitting phosphor has high luminosity and broad color gamut, is invulnerable to mechanical damage, and can create uniform images, and thus, is very useful in fabrication of a high quality plasma display panel.

### BACKGROUND OF THE INVENTION

1. Field of the Invention

The present invention relates to a novel blue barium magnesium aluminate (BAM) phosphor and a method for preparing the same. More particularly, the present invention relates to a blue BAM phosphor in which a magnetoplumbite phase is epitaxially formed as a protection film on the β-phase of a BAM phosphor.

2. Description of the Related Art

Barium magnesium aluminate (BAM; [(Ba,Eu²⁺)MgAl₁₀O₁₇]) has been widely used as a blue-emitting phosphor in PDPs (Plasma Display Panels) or three wavelengths fluorescent lamps.

However, a BAM phosphor is well known to undergo luminance degradation during heat treatment in fabrication of application products or luminance degradation under gas discharge in use of application products. For the former, for example, the luminance degradation of a BAM phosphor is caused during a Binder Burn-Out (BBO) process (at 450-510° C. for PDPs and at 700-750° C. for fluorescent lamps) or during coupling upper and lower plates at about 450° C. in fabrication of PDPs. The BAM has β-alumina structure, and more specifically, has an alternately stacked layered structure of a closed packed MgAl₁₀O₁₆ spinel layer and a relatively low density (Ba,Eu)O layer called “conduction layer”. The conduction layer has spaces that can be occupied by small molecules such as water molecules.

Due to such a characteristic structure of the BAM, there arises a change in luminance characteristics under specific conditions as described above. Generally, the change in luminance characteristics is called “luminance degradation” since it occurs in the direction that lowers the performance of a BAM phosphor. Luminance degradation is characterized by decrease of emission efficiency and change of emission color. Recently, many reports about scientific examination of the causes of the luminance degradation of a BAM phosphor have been published, and at the same time, many efforts have been made to minimize luminance degradation.

First, with respect to thermal luminance degradation, there have been mainly reported the decrease in emission efficiency due to oxidation of a BAM phosphor, i.e., oxidation of an Eu²⁺ activator to Eu³⁺, by oxygen in air or water during heat treatment [S. Oshio et al, Journal of the Electrochemical Society, 145(11), 3903, 1998] and the decrease in emission efficiency and the change in emission color by infiltration of water molecules into the crystal structure of a BAM phosphor [T. H. Kwon et al, Proceedings of Asia Display/IDW 01, 1051; T. H. Kwon et al, Journal of the Society for Information Display, 10(3), 241, 2002].

Second, with respect to luminance degradation by gas discharge, there has been reported the decrease in emission efficiency or the change in emission color due to damage to the crystal structure of a BAM phosphor by physical collision of the phosphor with ultraviolet light (UV) or ionized gases generated upon discharge [M. Ishimoto et al, Extended Abstracts of the Fifth International Conference on the Science and Technology of Display Phosphors (San Diego, Calif., 1999), p. 361.364; S. Tadaki et al., SID International Symposium Digest Tech Papers, 418.421, 2001].

The luminance degradation of a BAM phosphor reduces the quality of application products. To solve this problem, many efforts have been reported. For example, Japanese Patent Laid-Open Publication No. 2003-82345 discloses improvement of the luminance degradation, chromaticity change, and discharge characteristics of a BAM phosphor, based on the assumption that oxygen deficiency in a conduction layer of the BAM phosphor is a main causative factor of the degradation of the BAM phosphor and elimination of the oxygen deficiency prevents the adsorption of water or CO₂ to the BAM phosphor, thereby improving the luminance degradation, chromaticity change, and discharge characteristics of the BAM phosphor. In detail, the improvement of the luminance degradation, chromaticity change, and discharge characteristics of a BAM phosphor can be achieved by partial oxidation of Eu²⁺ ions to Eu³⁺ ions without addition of a separate compound or by formation of an oxide film or a fluoride film by addition of Al, Si, or La. Japanese Patent Laid-Open Publication No. 2003-82344 discloses a method of improving the degradation of a BAM phosphor by increasing positive charges by substitution of a tetravalent element (Ti, Zr, Hf, Si, Sn, Ge, or Ce) for Al or Mg in a spinel layer of the BAM phosphor to eliminate oxygen deficiency in a conduction layer of the BAM phosphor which is a main cause of phosphor degradation suggested in Japanese Patent Laid-Open Publication No. 2003-82345. Japanese Patent Laid-Open Publication No. 2003-382343 discloses a method of preventing the luminance degradation of a BAM phosphor by coating the BAM phosphor with oxide such as SiO₂, Al₂O₃, ZnO, MgAl₂O₄, Ln₂O₃, LaPO₄, and Zn₂SiO₄ or fluoride such as Si(OF)₄, La(OF)₃, and Al(OF)₃ followed by heating at 300-600° C. in air to prevent the adsorption of water or CO₂ to the BAM phosphor due to oxygen deficiency in a conduction layer of the BAM phosphor.

Meanwhile, Japanese Patent Laid-Open Publication No. 2002-348570 discloses a heat treatment of a blue-emitting silicon-containing BAM phosphor at 500-800° C. in air to enhance degradation characteristics of the BAM phosphor by vacuum ultraviolet (VUV) radiation. Korean Patent Laid-Open Publication No. 2003-14919 discloses a technique of minimizing the degradation of a BAM phosphor by selective surface treatment (coating) of the BAM phosphor, i.e., a technique of preventing thermal degradation of a BAM phosphor by the selective chemical surface treatment of only a crystal plane parallel to the c-axis of a phosphor crystal, based on the assumption that thermal degradation of a BAM phosphor is caused by moisture infiltration into the crystal structure of the BAM phosphor during a high-temperature treatment process in fabrication of plasma panels, for example a BBO process or a coupling process of upper and lower plates. Korean Patent Laid-Open Publication No. 2002-0025483 discloses a technique of preventing the degradation of a BAM phosphor by continuous coating of SiO₂ to a thickness of 5-40 nm on a surface of the BAM phosphor, U.S. Pat. No. 5,998,047 discloses a technique of preventing the degradation of a BAM phosphor by UV by coating the BAM phosphor with catena polyphosphates, Japanese Patent Laid-Open Publication No. 2000-303065 discloses a technique of preventing the thermal degradation of a blue-emitting BAM phosphor which is a VUV phosphor by coating the phosphor with Ba or Sr compounds such as borates, phosphates, silicates, halogens, nitrates, sulfates, and carbonates, and Japanese Patent Laid-Open Publication No. 2002-080843 discloses a technique of preventing the degradation of a first BAM phosphor by coating the first BAM phosphor with a second BAM phosphor emitting UV light exciting the first BAM phosphor.

The above-described prior arts can be grouped into two categories: heat treatment of a blue-emitting BAM phosphor with slight composition change in air to reduce degradation by VUV radiation and surface treatment of a blue-emitting BAM phosphor with no composition change. For the former technique, luminosity maintenance is mentioned but a change in emission color is not considered. In particular, since only prevention of the degradation by WV radiation is considered, there is no information about improvement of degradation that may be caused in actual panel fabrication. On the other hand, the latter technique is a degradation prevention technique by formation of a protection film on a surface of a BAM phosphor and can be sub-grouped into formation of a protection film on a surface portion of a BAM phosphor (e.g., Korean Patent Laid-Open Publication No. 2003-14919) and formation of a protection film on the entire surface of a BAM phosphor.

The formation of a protection film on the entire surface of a BAM phosphor induces the change in emission efficiency according to a coating amount. Reduction in emission efficiency increases as the coating amount increases. On the other hand, as the coating amount decreases, prevention of degradation of a BAM phosphor may be insufficient. Further, a coating material serves as a protection film but may serve as a binder, thereby causing the agglomeration of phosphor particles. The agglomerated phosphor particles may not form a uniform coating film in actual use due to poor dispersion property and may cause a change in luminance characteristics, i.e., decrease in emission efficiency and change in emission color due to high-temperature chemical reaction between a coating material and phosphor particles, thereby causing the degradation of a BAM phosphor. Furthermore, the above-described protection film is a simple physical coating film with no chemical bond between a BAM phosphor and a coating material. Therefore, the protection film is vulnerable to mechanical damage in actual application, thereby causing the degradation of a BAM phosphor.

To solve these problems of a blue-emitting BAM phosphor with composition change for improvement of only luminosity maintenance and a blue-emitting BAM phosphor coated with a simple protection film with no composition change for desired emission color, the present inventor developed a novel blue BAM phosphor in which only a specific crystal plane of a BAM phosphor, i.e., only a crystal plane parallel to the c-axis of the BAM phosphor is selectively surface-modified by a magnetoplumbite structure which is chemically bonded to the BAM phosphor and is physicochemically very similar to the β-alumina structure of the BAM phosphor, and thus completed the present invention.

### SUMMARY OF THE INVENTION

In view of these problems, the present invention provides a novel blue BAM phosphor in which a magnetoplumbite phase is epitaxially formed as a protection film on the β-phase of a blue BAM phosphor, and a high quality plasma display panel (PDP) using the blue BAM phosphor, which has high luminosity and broad color gamut, is invulnerable to mechanical damage, and can create a uniform image.

According to an aspect of the present invention, there is provided a novel blue BAM phosphor in which a magnetoplumbite phase is epitaxially formed as a protection film on the β-phase of a BAM [(M^{II},Eu²⁺)MgAl₁₀O₁₇] phosphor.

### BRIEF DESCRIPTION OF THE DRAWINGS

FIGS. 1 and 2 are transmission electron microscopic (TEM) images of a blue-emitting barium magnesium aluminate (BAM) phosphor with a too thick magnetoplumbite (MP) phase in which an interface is formed between the MP phase and the β-phase of the BAM phosphor and nano-cracks are formed in the MP phase; and

FIG. 3 is emission spectra before and after a moisture resistance test.

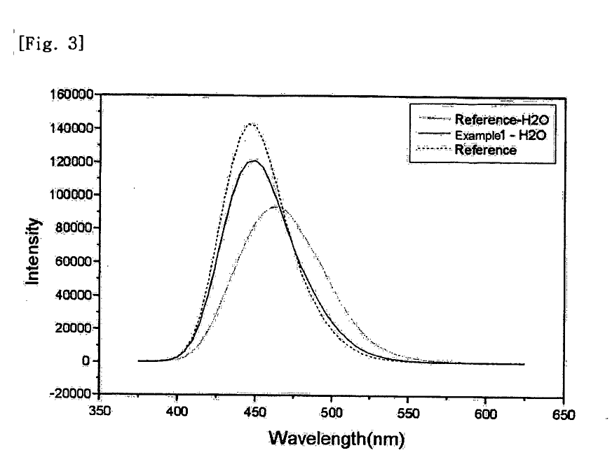

### DETAILED DESCRIPTION OF THE INVENTION

Hereinafter, the present invention will be described in detail.

In more detail, the present invention relates to a blue BAM phosphor in which a magnetoplumbite (MP) phase is formed on a surface of a barium magnesium aluminate (BAM) phosphor with β-alumina phase with or without addition of a MP phase-forming material capable of chemically bonding to the surface of the B AM phosphor, i.e., the MP phase is epitaxially grown on the β-alumina phase. Such epitaxial growth is achieved by similar crystal structure and very similar lattice constant between the β-alumina phase and the MP phase [J. M. P. J. Verstegen et al., Journal of Luminescence, 9, 406. 414, 1974; N. Iyi et al., Journal of Solid State Chemistry, 83, 8.19, 1989; ibid, 47, 34, 1983].

MP is a material having a crystal structure very similar to β-alumina, and may be represented by formula 1 below:
M₁^{(II)M′}^{(III)}₁₂O₁₉ <Formula 1>
wherein M₁(II) is Ca, Sr, Pb, or Eu, and M′(III) is Al, Ga, or a combination thereof.

The MP may also be represented by formula 2 below:
M₂^{(III)}M″^{(II)}M′^{(III)}₁₁O₁₉ <Formula 2>
wherein M₂^{(III)} is a lanthanide metal such as La, Ce, Pr, Nd, Sm, Eu, and Gd, M″^{(II)} is Ni, Co, Fe, Mn, or Mg, and M′^{(III)} is Al, Ga, or a combination thereof.

The MP may also be represented by formula 3 below:

M₃^{(III)}M′^{(III)}₁₁O₁₈ <Formula 3>

wherein M₃^{(III)} is La, Ce, or a combination thereof, and M′^{(III)} is Al, Ga, or a combination thereof.

In particular, only a crystal plane parallel to the c-axis of the BAM phosphor is selectively chemically surface-modified by the MP phase.

Hereinafter, the present invention will be described provided that M′^{(III)} is Al for convenience of illustration.

The MP structure is different from the 3-alumina structure only in terms of a conduction layer. With respect to the β-alumina structure, the configuration of atoms constituting a M^{(II)}O conduction layer, i.e., M^{(II)} and oxygen atoms is less dense, and thus, there are many spaces between the constitutional atoms. However, the MP structure has a M^{(III)}AlO₃ conduction layer which is composed of more atoms, and thus, forms a closed packed structure with no spaces [N. Iyi et al., Journal of Solid State Chemistry, 26, 385, 1983; T. Gbehi et al., Materials Research Bulletin, 22, 121.129, 1987]. Therefore, the MP structure has less likelihood of infiltration of small molecules such as water molecules into its conduction layer and does not exhibit high ionic conductivity at high temperature, unlike the β-alumina structure.

The novel blue BAM phosphor according to the present invention provides the following advantages and effects.

First, the blue-emitting phosphor of the present invention hardly exhibits degradation of the phosphor when it is applied to products such as PDPs, i.e., when a high-temperature treatment is performed in fabrication of PDPs. Since chemical bonding between a protection film and BAM phosphor particles is performed at a higher temperature, i.e., at a temperature above a heat treatment temperature required in fabrication of an application product, the emission color of the blue-emitting phosphor of the present invention is almost the same as or a deeper blue than that of a conventional blue-emitting BAM phosphor with only β-alumina structure. Therefore, the blue-emitting phosphor of the present invention is a high quality phosphor that does not exhibit degradation of luminance characteristics even when used at high temperature, for example at more than 400° C.

For example, in PDP fabrication, the blue-emitting phosphor of the present invention does not undergo luminance degradation by moisture infiltration into the crystal structure of the phosphor at high temperature (400-510° C.), and thus does not exhibit the decrease of emission efficiency and emission color purity, i.e., the change in emission color (increase in y value in the C.I.E. color coordinates) from deep blue to greenish blue. Therefore, fabrication of a high quality PDP with high luminosity and broad color gamut is achieved.

Second, images created by a PDP including the blue-emitting phosphor of the present invention are remarkably enhanced in performance reduction with time, i.e., brightness reduction and calorimetric shift, relative to those created by a PDP including a conventional blue-emitting BAM phosphor. Therefore, an application product using the blue-emitting phosphor of the present invention can have an extended lifetime.

Third, the blue-emitting phosphor of the present invention has a strong chemical bonding between the MP phase used as a protection film and the 13-phase of the BAM phosphor, thereby ensuring strong resistance to mechanical damage, unlike a conventional BAM phosphor with a simple protection film. Therefore, a mechanical damage that may be involved upon actual application of a phosphor does not occur, thereby ensuring the fabrication of a high quality application product.

Fourth, the blue-emitting phosphor of the present invention does not undergo agglomeration between phosphor particles, thereby ensuring good dispersibility when used. Therefore, a uniform phosphor film can be formed, which ensures uniform image creation over the entire screen of an application product such as a PDP.

The present invention also provides a method for preparing a novel blue BAM phosphor.

In more detail, the present invention provides a method for preparing a blue BAM phosphor in which a MP phase is chemically bonded to the β-phase of a BAM phosphor. The preparation method for the blue-emitting phosphor can be largely divided into two categories: simple surface restructuring of the β-phase of the BAM phosphor with no addition of a separate compound; and coating the 3-phase with a MP phase-forming composition followed by high-temperature treatment for chemical bonding between the two phases.

Illustrative preparation methods for blue-emitting phosphors according to the present invention will now be described.

(Method I)

The present invention provides a method for preparing a blue-emitting phosphor, including heating a BAM phosphor with β-phase under an oxidizing atmosphere with no addition of a separate compound to form a MP phase.

The method I is simply represented by the following scheme 1:

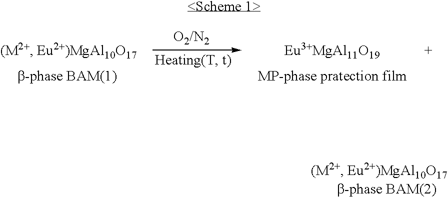

wherein M is Ca, Sr, Ba, or a combination thereof, O₂/N₂ ratio is 0.01 to 100%, preferably 0.01 to 10%, and more preferably 0.1 to 5%, T is a heating temperature ranging from 800 to 1,200° C., preferably from 950 to 1,050° C., and t is a heating time ranging from 1 minute to 10 hours, and preferably from 0.5 to 3 hours. The heating can be optimally performed by adjusting the amount of the β-phase BAM phosphor, the O₂/N₂ ratio, the heating temperature, and the duration of heating.

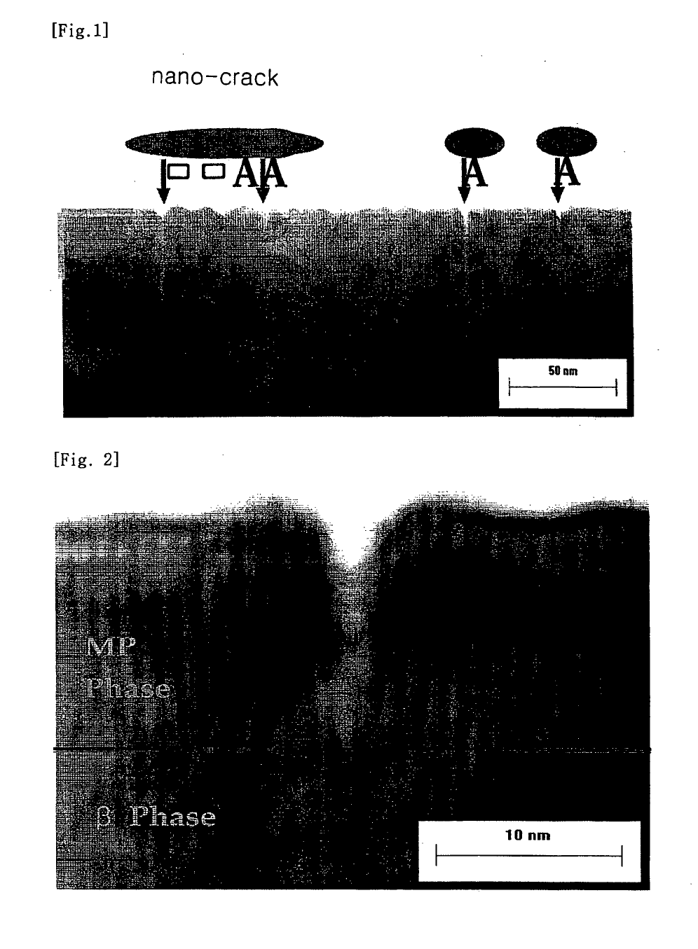

As used herein, the phrase “the heating can be optimally performed” indicates that oxidation can be minimized so that the reduction of emission efficiency of the BAM phosphor with β-phase is minimized and the MP phase sufficiently acts as a protection film. That is, the phrase “the heating can be optimally performed” indicates that the heating can be performed so that minimization of reduction in emission efficiency and best function of the MP phase as a protection film are ensured. The MP phase thus formed has a thickness of 0.5-5 nm, preferably 0.5-2 nm. If the thickness of the MP phase is too thick, the lattice misfit between the β phase and the MP phase, in particular, nano-cracks a long the c-axis (vertical plane with respect to a conduction layer) is caused. Therefore, the function of the MP phase as a protection film may be poor, which makes it impossible to efficiently perform degradation prevention. FIGS. 1 and 2 show transmission electron microscopic (TEM) images of a blue-emitting BAM phosphor with a too thick MP phase. Referring to FIGS. 1 and 2, the MP phase is formed on a crystal plane parallel to the c-axis of the BAM phosphor and nano-cracks with a width of 5 nm and a depth of 12 nm are formed at 60 nm intervals along the c-axis. In this case, the lattice constant of the β-phase is as follows: a=b=5.65 Å and c=22.8 Å, and the lattice constant of the MP phase is as follows: a=b=5.71 Å and c=22.0 Å, which is included in the region reported before and shows that the MP phase is epitaxially formed on the β-phase. It is judged that the nano-cracks are formed to relieve stress at a crystal structure due to the lattice misfit between the MP phase and the β-phase. In this respect, to prevent the formation of nano-cracks, it is preferable that the MP phase of a blue BAM phosphor has a thickness of 0.5 to 2 nm, like a blue BAM phosphor of Example 1 as will be described later.

(Method II): Formation of MP Phase at Low Temperature (Using Metal Fluoride)

(Method II-1)

The present invention provides a method for preparing a blue-emitting phosphor, including adding metal fluoride to a BAM phosphor to obtain a mixture and heating the mixture under an oxidizing atmosphere in which O₂/N₂ ratio is in the range of 0.01 to 100% at 650-850° C. for 0.5 to 2 hours to form a MP phase.

The metal fluoride may be divalent metal fluoride such as MgF₂, ZnF₂, or SnF₂, or trivalent metal fluoride such as AlF₃ or GaF₃. The metal fluoride is used in an amount of 0.001 to 0.02 g, preferably 0.001 to 0.01 g, based on 1 g of the BAM phosphor.

(Method II-2)

The present invention provides a method for preparing a blue-emitting phosphor, including exchanging Ba or Eu ions in a conduction layer of a BAM phosphor for a cation (M) capable of forming a MP phase and heating the ionically exchanged BAM phosphor under an oxidizing atmosphere to form a MP phase. At this time, to decrease a heating temperature, cation (M) fluoride capable of forming a MP phase may be used. When metal fluoride containing metal cation as an ion exchange material is used, the heating temperature can be reduced to 650-750° C.

The cation (M) is Ca²⁺, Sr²⁺, Eu³⁺, La³⁺, or Gd³⁺, and is used in an amount of 0.001 to 0.02 g, based on 1 g of the BAM phosphor.

In detail, the method II-2 is divided into two categories: one method is to mix a BAM phosphor with cation fluoride (MFₓ) in a predetermined ratio and the other method is to use a stock solution.

For the latter, a BAM phosphor is mixed with a stock solution. The stock solution may be a fluoride stock solution prepared by adding a NH₄F solution to a cation nitride-containing aqueous solution, M(NO₃)ₓ yH₂O, based on a mole ratio.

The ratio of O₂/N₂ under the oxidizing atmosphere is in the range of 0.01 to 100% and the heating is performed at 650-850° C. for 0.5 to 2 hours.

The BAM phosphor mixed with c ation fluoride is heated under an oxygen partial pressure at a rate of 10° C./min at a temperature ranging from 650 to 750° C. for 1.2 hours and then cooled at a rate of 10° C./min to prepare a novel phosphor with moisture resistance.

The method II-2 can be represented by the following scheme 2:

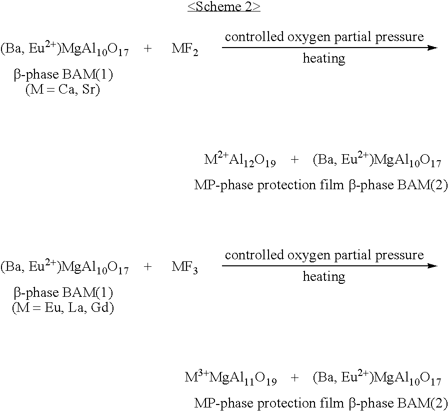

1) A BAM phosphor is mixed with MFₓ in a predetermined ratio and heated at 650 to 750° C. under a predetermined oxygen partial pressure.

2) A fluoride stock solution obtained according to the following reaction scheme may also be used instead of MFₓ of 1):
M(NO₃)ₓ yH₂O+xNH₄F→MFₓ+xNH₄NO₃+yH₂O

(Method II-3)

The present invention provides a method for preparing a blue-emitting phosphor, including adding metal fluoride and metal nitride to a BAM phosphor with β-phase to obtain a mixture and heating the mixture under an inert atmosphere at 650-750° C. for 0.5 to 2 hours.

That is, to prepare a blue-emitting phosphor with moisture resistance, i.e., with enhanced degradation characteristics, the method II-1 (method using metal fluoride to decrease a heating temperature) and the method II-2 (method of ionically exchanging Ba or Eu ions in a conduction layer of a BAM phosphor for a cation capable of forming a MP phase) can be used at the same time.

The metal fluoride may be divalent metal fluoride such as MgF₂, ZnF₂, or SnF₂, or trivalent metal fluoride such as AlF₃ or GaF₃. The metal fluoride is used in an amount of 0.001 to 0.02 g, based on 1 g of the BAM phosphor. The heating temperature can be adjusted according to the used amount of MgF₂ or AlF₃. Due to solubility in water, AlF₃ can form a uniform mixture with a BAM phosphor. When a stock solution is used instead of MgF₂ or AlF₃, a BAM phosphor is mixed with a Al(NO₃)₃ 9H₂O or Mg(NO₃)₂ 6H₂O stock solution and then a NH₄F stock solution is added thereto, based on mole ratio.

A metal ion to be ionically exchanged may be added in the form of a stock solution represented by L(NO₃)ₓ yH₂O. Here, L is Ca²⁺, Sr²⁺, Eu³⁺, La³⁺, or Gd³⁺, and is used in an amount of 0.001 to 0.02 g, based on 1 g of the BAM phosphor.

The inert atmosphere is maintained by nitrogen, argon, or a mixed gas thereof.

According to the method II-3, a BAM phosphor is mixed with addition materials and dried. Then, the mixture is heated under a controlled inert atmosphere at a rate of 10° C./min at a temperature ranging from 650 to 850° C. for 0.5 to 2 hours and then cooled at a rate of 10° C./min to obtain a novel blue-emitting phosphor.

The method II-3 simultaneously uses the methods II-1 and II-2 to facilitate the formation of a MP phase and can be represented by the following scheme 3:

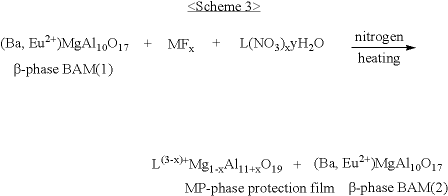

wherein M is Mg²⁺ or Al³⁺, and L is Ca²⁺, Sr²⁺, or a trivalent lanthanide metal.

1) A BAM phosphor is mixed with MFₓ and L(NO₃)ₓ yH₂O in a predetermined ratio (1-20 mmol/g BAM, preferably 18 mmol/g BAM for MFₓ, and 1-10 mmol/g BAM, preferably 6-9 mmol/g BAM for L(NO₃)ₓ yH₂O) and then heated at 650-850° C. under a nitrogen atmosphere or an inert atmosphere.

2) MFₓ and L(NO₃)ₓ yH₂O of 1) may be prepared using the following stock solutions: M(NO₃)ₓ yH₂O, x(NH₄)F, L(NO₃)_{w} zH₂O

(Method III)

The present invention provides a method for preparing a blue-emitting phosphor, including adding a MP phase-forming material to a BAM phosphor to obtain a mixture and heating the mixture under an inert atmosphere.

The MP phase-forming material is obtained by mixing M₁X₃, M₂(NO₃)₂, and Al(OR)₃. Here, M₁ is a lanthanide metal such as Eu³⁺, Ce³⁺, or La³⁺, X_{3 is Cl}⁻ or NO³⁻, M₂ is Mg²⁺, and OR is alkoxide. M₁ is used as in an amount of 0.002 to 0.05 mmole, based on 1 g of the BAM phosphor.

The inert atmosphere is maintained by nitrogen, argon, or a mixed gas thereof, and the heating temperature is in the range of 800 to 1,000° C.

The method III is a method of forming a MP phase as a protection film on the BAM phosphor by heating after addition of a MP phase-forming material and can be simply represented by the following scheme 4:

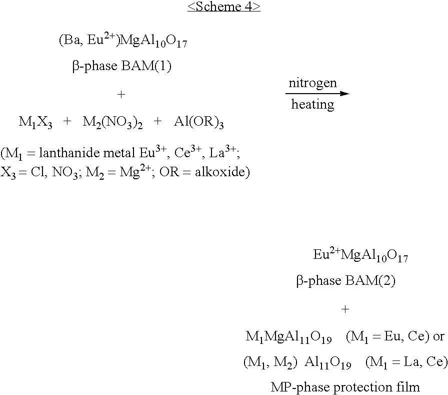

Hereinafter, the present invention will be described specifically by Examples. However, the following Examples are provided only for illustrations and thus the present invention is not limited to or by them.

### COMPARATIVE EXAMPLE 1

Ba, Eu, Mg, and Al were mixed in a mole ratio of 0.9:0.1:1.0:10 and an appropriate amount of AlF₃ as a flux was added thereto. Then, the mixture was calcined under a mixed gas atmosphere of nitrogen and hydrogen (95:5, v/v) at 1,400° C. for 2 hours.

The calcined body thus obtained were ball-milled, washed with water, and dried to give a phosphor with a composition of Ba_{0.9}Eu_{0.1}MgAl₁₀O₁₇ (BAM: Eu²⁺).

### EXAMPLE 1

500 g of the BAM: Eu²⁺ phosphor prepared in Comparative Example 1 was placed in a crucible, and a heat treatment was performed as the following temperature profile: heating at a rate of 5° C./min under a mixed gas (N₂+O₂) (0.1 volume %), maintenance at 1,000° C. for two hours, and cooling at a rate of 5° C./min, to give a desired blue BAM phosphor.

### EXAMPLE 2

A mixture of 500 g of the BAM: Eu²⁺ phosphor prepared in Comparative Example 1 and 1.25 g of AlF₃ was placed in a crucible and a heat treatment was performed as the following temperature profile: heating under a mixed gas (2.5 wt % Air/N₂+Air) at a rate of 5° C./min, maintenance at 750° C. for one hour, and cooling at a rate of 5° C./min, to give a desired blue BAM phosphor.

### EXAMPLE 3

1 g of the BAM: Eu²⁺ phosphor prepared in Comparative Example 1, 0.2975 mmol (0.0608 g) of aluminum isopropoxide (Al(OⁱPr)₃), 0.0035 mmol (0.00152 g) of cerium nitrate (Ce(NO₃)₃(6H₂O), and 0.0215 mmol (0.0093 g) of lanthanum nitrate (La(NO₃)₃(6H₂O) were stirred in 10 ml of distilled water and heated to remove a solvent. Phosphor powders thus obtained were heated to 900° C. under a nitrogen atmosphere at a rate of 10° C./min for two hours to give a desired blue BAM phosphor.

### EXPERIMENTAL EXAMPLE 1

### Degradation Test of Blue-Emitting Phosphors

The function of a protection film was relatively evaluated by measuring the degree of reduction of luminance characteristics (thermal degradation) by moisture infiltration into a conduction layer of a blue-emitting phosphor. It was evaluated that as the degree of reduction in luminance characteristics decreases, the function of a protection film is excellent.

This test was performed according to the following conditions based on a publicly known document [T. H. Kwon et al, Proceedings of Asia Display/IDW'01, 1051; T. H. Kwon et al, Journal of the Society for Information Display, 10(3), 241, 2002].

Moisture Resistance Test Conditions
Heating rate: 10° C./min
Maintenance temperature and time: 450° C., 1 hr
Cooling rate: 10° C./min
Test amount: 5 g

First, to assure reliability of the moisture resistance test, a moisture resistance test was performed for the phosphor of Example 1 and 42″ PDP using the phosphor of Example 1 and the results are presented in Tables 1 and 2, respectively. As shown in Tables 1 and 2, the 42″ PDP and the phosphor were almost the same in emission efficiency and color coordinates. In this respect, degradation characteristics of the phosphors of Examples can be simply predicted even when the phosphors are not mounted on PDPs. Thus, the moisture resistance will be described considering it as the maintenance capability of luminance characteristics of the phosphors in a degradation environment.

TABLE 1

| | | Relative emission |
|---|---|---|
| Phosphor test | Color coordinates (x/y) | efficiency (%) |
| Comparative | 0.1351/0.1133 | 85 |
| Example 1 | | |
| Example 1 | 0.1448/0.0603 | 92.2 |
| Before moisture | 0.1476/0.0493 | 100 |
| resistance test | | |

TABLE 2

| | Comparative | |
|---|---|---|
| 42″ PDP test | Example 1 | Example 1 |
| Emission efficiency (%) | 100 | 128 |

| | | | |
|---|---|---|---|
| Color coordinates | X | 0.145 | 0.143 |
| | Y | 0.096 | 0.066 |

Luminance characteristics results of the phosphors prepared in Examples 1-3 based on moisture resistance tests are presented in Table 3. As shown in Table 3, the phosphors prepared in Examples 1-3 exhibited relatively excellent degradation characteristics, as compared to a conventional blue BAM phosphor.

TABLE 3

| | Emission | Color coordinates |
|---|---|---|
| Section | efficiency²⁾ (%) | (x, y) |
| Example 1 | 92.2 | 0.145, 0.060 |
| Example 2 | 95.1 | 0.145, 0.057 |
| Example 3 | 92.4 | 0.145, 0.065 |
| Comparative | 85 | 0.135, 0.113 |
| Example 1 | | |
| Before moisture | 100 | 0.148, 0.049 |
| resistance test¹⁾ | | |

¹⁾Before moisture resistance test of the phosphor of Comparative Example 1
²⁾Emission efficiency of the phosphor of Comparative Example 1 before moisture resistance test is 100%

The luminance characteristics of a novel blue BAM phosphor of the present invention exhibit different enhancements of degradation characteristics according to the added amount of a MP phase-forming material and a heating temperature. When a heating temperature is less than 800° C. or the added amount of a MP phase-forming material is less than 0.002 mmol/1 g BAM, enhancement of degradation characteristics is insignificant. Therefore, it is preferable that the added amount of a MP phase-forming material is more than 0.002 mmol/1 g BAM (0.002-0.05 mmol/1 g BAM), and a heating is performed in a nitrogen atmosphere at 800° C. or more (heating rate: 10° C./min) for 1 hour or more. If the heating is performed at 1,000° C. for 2 hours or more, the moisture resistance of a blue-emitting phosphor increases but reduction of emission efficiency due to a MP phase formed on β-phase also increases.

As apparent from the above description, a phosphor according to the present invention is a blue-emitting phosphor in which a MP phase is epitaxially formed on the β-phase of a BAM phosphor. Therefore, the phosphor of the present invention has high luminosity and broad color gamut, is invulnerable to mechanical damage, and can create a uniform image, and thus is very useful in fabrication of a high quality PDP.

1. A blue BAM[(M^{II},EU²⁺)MgAl₁₀O₁₇] phosphor in which a magnetoplumbite phase is epitaxially formed as a protection film on the β-phase of a blue BAM phosphor.

2. The blue-emitting phosphor of claim 1, wherein M^{II} is Ba, Ca, Sr, or a combination thereof and Al is wholly or partially substituted by Ga.

3. The blue-emitting phosphor of claim 1, wherein the magnetoplumbite phase has a composition of M₁²⁺ Al₁₂O₁₉,
wherein when M₁²⁺ is Ca or Sr, the magnetoplumbite phase has a composition of M₂³⁺MgAl₁₀O₁₉, and
wherein when M₂³⁺ is Eu, La, Gd, Ce, or a combination thereof, the magnetoplumbite phase has a composition of M₃³⁺Al₁₁O₁₈, and where M₃³⁺ is La, Ce, or a combination thereof and Al is wholly or partially substituted by Ga.

4. The blue-emitting phosphor of claim 1, wherein only a crystal plane parallel to the c-axis of the BAM phosphor crystal is selectively chemically surface-modified by the magnetoplumbite phase.

5. A method for preparing the blue-emitting phosphor of claim 1, comprising heating a BAM phosphor with β-phase under an oxidizing atmosphere with no addition of a separate compound to form a magnetoplumbite phase.

6. The method of claim 5, wherein O₂/N₂ ratio in the oxidizing atmosphere is in the range of 0.01 to 100% and the heating is performed at a temperature of 800 to 1,200° C. for 1 minute to 10 hours.

7. The method of claim 5, wherein the magnetoplumbite phase has a thickness of 0.5 to 5 nm.

8. A method for preparing the blue-emitting phosphor of claim 1, comprising adding metal fluoride to a BAM phosphor to obtain a mixture and heating the mixture under an oxidizing atmosphere in which O₂/N₂ ratio is in the range of 0.01 to 100% at a temperature of 650 to 850° C. for 0.5 to 2 hours.

9. The method of claim 8, wherein the metal fluoride is divalent metal fluoride selected from the group consisting of MgF₂, ZnF₂ and SnF₂, or trivalent metal fluoride selected from the group consisting of AlF₃ and GaF₃.

10. The method of claim 8, wherein the metal fluoride is used in an amount of 0.001 to 0.02 g, based on 1 g of the BAM phosphor.

11. A method for preparing the blue-emitting phosphor of claim 1, comprising partially ionically exchanging Ba or Eu ions in a BAM phosphor with β-phase for cation fluoride capable of forming a magnetoplumbite phase and heating the ionically exchanged BAM phosphor under an oxidizing atmosphere.

12. The method of claim 11, wherein the cation is Ca²⁺, Sr²⁺, Eu³⁺, La³⁺, or Gd³⁺, and is used in an amount of 0.001 to 0.02 g, based on 1 g of the BAM phosphor.

13. The method of claim 11, wherein the cation fluoride is prepared by adding a NH₄F solution to a cation nitride-containing aqueous solution.

14. The method of claim 11, wherein O₂/N₂ ratio in the oxidizing atmosphere is in the range of 0.01 to 100%, and the heating is performed at 650 to 850° C. for 0.5 to 2 hours.

15. A method for preparing the blue-emitting phosphor of claim 1, comprising adding metal fluoride and metal nitride to a BAM phosphor with β-phase to obtain a mixture and heating the mixture under an inert atmosphere at a temperature of 650 to 750° C. for 0.5 to 2 hours.

16. The method of claim 15, wherein the metal fluoride is divalent metal fluoride selected from the group consisting of MgF₂, ZnF₂, and SnF₂, or trivalent metal fluoride selected from the group consisting of AlF₃ and GaF₃.

17. The method of claim 15, wherein a metal ion of the metal nitride is Ca²⁺, Sr²⁺, Eu³⁺, La³⁺, or Gd³⁺, and is used in an amount of 0.001 to 0.02 g, based on 1 g of the BAM phosphor.

18. The method of claim 15, wherein the inert atmosphere is a nitrogen atmosphere, an argon atmosphere, or its mixed gas atmosphere.

19. A method for preparing the blue-emitting phosphor of claim 1, comprising adding M₁X₃, M₂(NO₃)₂, and Al(OR)₃ to a BAM phosphor to obtain a mixture and heating the mixture under an inert atmosphere.

20. The method of claim 19, wherein M₁ is a lanthanide metal selected from the group consisting of Eu³⁺, Ce³⁺, and La³⁺, X₃ is Cl⁻ or NO³⁻, M₂ is Mg²⁺, and OR is alkoxide.

21. The method of claim 19, wherein M₁ is used in an amount of 0.002 to 0.05 mmole, based on 1 g of the BAM phosphor.

22. The method of claim 19, wherein the inert atmosphere is a nitrogen atmosphere, an argon atmosphere, or a mixed gas atmosphere thereof, and the heating is performed at a temperature of 800 to 1,000° C.
